(19) United States
(12) Patent Application Publication
(10) Pub. No.: US 2009/0315350 A1
(43) Pub. Date: Dec. 24, 2009

(54) COLLECTION AND STORAGE POCKET AND METHODS OF USE

(76) Inventor: Betty Mae Allen, Burien, WA (US)

Correspondence Address: Patentique PLLC, P.O. Box 5803, Bellevue, WA, 98006, US

(21) Appl. No.: 12/484,922

(22) Filed: Jun. 15, 2009

Related U.S. Application Data
(60) Provisional application No. 61/073,531, filed on Jun. 18, 2008.

(51) Int. Cl. A01K 29/00

(52) U.S. Cl. 294/1.3

(57) ABSTRACT

The disclosure relates to a carrier comprising a sleeve and a liner that can be used to collect and transport items. The carrier may be used in connection with the collection and disposal of waste items, including but not limited to, animal waste. The apparatus of the present disclosure combines the usefulness of a carrier or bag to hold items or products with features that assist in acquiring the items themselves. Thus, the apparatus may serve as an apparatus for collecting waste and other items and as an extra “pocket” for storing the waste and personal items. The present invention further provides a way to carry waste and other potentially unsanitary items away from contact with the person picking up the waste, as well as providing an extra layer of protection when picking up waste.

### PRIORITY

This application claims benefit of priority from U.S. Provisional Patent Application No. 61/073,531, filed Jun. 18, 2008, which is hereby incorporated by reference as if fully set forth.

### FIELD OF THE DISCLOSURE

This disclosure relates to an apparatus that may be used to pick up and carry items, and methods of using the apparatus.

### BACKGROUND OF THE DISCLOSURE

Dog ownership brings with it the responsibility of proper cleanup of waste. Pets and urban wildlife can be significant bacterial sources. In most major urban areas in the United States, the city encourages dog owners to place dog waste collection bags in their trash. Our landfills are designed to safely handle dog waste. Dog waste in the landfill keeps it out of the waterways and watersheds.

In many places across the country, many dog owners enjoy hiking with their dogs. However, many trails employ the “pack it in, pack it out” philosophy, which means there are no trash cans on the trails, and certainly no trash cans in the woods. Being able to hike with dogs without carrying dog waste bags in the hikers' hands makes hiking with pets much more enjoyable, and eco-friendly.

There are a number of products being marketed to the dog owner that address the problem of dealing with waste when walking a dog. These break down into two distinct categories: assistance in picking up waste or a temporary storage solution for transporting the collected waste.

In the first category, what consumers will find at most pet product stores are a small selection of plastic and biodegradable “poop bags,” which may include dispenser along with biodegradable bags. Aside from simple bags, there are a small number of disposable “scoops” available for purchase, which are a combination of cardboard and plastic. While most of these products are marketed as an easier and more sanitary way of picking up after a pet, these products do not provide a more sanitary and “hand-free” way of transporting the waste after collection.

The present invention promotes responsibility in dog ownership by making it easier to properly dispose of dog waste. It does this my solving two problems that every dog walker encounters: (1) it provides an extra layer of sanitary, moisture-resistant protection when picking up after a dog; and (2) it provides a place to carry the waste for the duration of the walk that keeps the waste away from both the dog walker and the dog. The apparatus of the present invention is lightweight, easy to use, reusable, durable, and washable. Designed to be used with any kind of waste pickup bag, as well as the standard supermarket carrier bag, the invention is helpful to anyone who may find it hard to pickup after their pet with only a thin layer of plastic over their hand, or to those who may pickup the waste, but who may not dispose of it properly because they are reluctant to carry the waste bag for the duration of their walk.

The citation of documents herein is not to be construed as reflecting an admission that any is relevant prior art. Moreover, their citation is not an indication of a search for relevant disclosures. All statements regarding the date(s) or contents of the documents is based on available information and is not an admission as to their accuracy or correctness.

### BRIEF SUMMARY OF THE DISCLOSURE

The disclosure relates to a carrier that can be used to collect and transport items. The carrier may be used in connection with the pick-up and disposal of waste items, including but not limited to, animal waste. The apparatus of the present disclosure combines the usefulness of a carrier or bag to hold items or products with features that assist in acquiring the items themselves. After the waste or items are acquired, they are dropped into the carrier, which can be removably clipped to a leash, backpack, purse, belt and the like. The carrier may function as an apparatus for collecting waste and other items and as an extra “pocket” for storing the waste and personal items. The present invention provides a way to carry waste and other potentially unsanitary items away from contact with the person picking up the waste, as well as providing an extra layer of protection when picking up waste. After the collection of waste, therefore, the transport of the waste in the carrier may be “hands free.” By keeping the waste away from the user, and by increasing the number of physical barriers between the user and the waste, the present invention provides a more sanitary means of collecting and transporting waste until the waste can be placed in the garbage.

It will further be evident from the disclosure herein that the carrier is intended for multiple reuse, in contrast to single-use products in the market today. The reuse of the carrier in picking up and transporting waste until the waste is ultimately disposed of limits the environmental impact of the present invention.

In a first aspect, the disclosure includes a carrier for picking up and isolating items. The carrier includes without limitation a sleeve and a liner.

In a second aspect, the disclosure includes a method for picking up and isolating items using a carrier that includes without limitation a sleeve and a liner.

In an additional aspect, the disclosure includes a system for carrying items that includes without limitation a carrier with a sleeve and liner, a strap that may be connected to the carrier, and separate bags that can be used to collect items. The bags, with or without the items, can be transported in the carrier.

In some embodiments, the apparatus and methods of the disclosure are practiced in relation to the pick-up of waste from animals such as dogs. The liner of the carrier may be used as a layer of protection between the hand and the dog waste, thereby providing a more sanitary means for picking up waste. The liner may be used in connection with a separate waste bag that is fitted over the liner before picking up the waste. After picking up the waste, the liner and the separate waste bag containing the waste may be retracted into the sleeve. The separate waste bag containing the waste is dropped into the liner and stored in the carrier.

In further embodiments, the methods and system of the disclosure are practiced in connection with a system for attaching the carrier to a leash, belt or other object when walking a dog. The system includes without limitation a strap that connects to the carrier. The strap may then be connected to another object. In yet further embodiments, the methods and system of the disclosure are practiced in connection with separate waste bags that fit over the liner when the carrier is used to pick up waste. The separate waste bags may be stored in a pocket of the carrier before use, and stored in the liner of the carrier after use.

### BRIEF DESCRIPTION OF THE FIGURES

FIG. 1 shows a representative carrier of the disclosure with a strap, with the liner in a stowed position.

FIG. 2 illustrates a representative carrier of the disclosure with a strap, with the liner in an extended position.

FIG. 3 illustrates a sectional view of an open carrier of the disclosure.

FIG. 4 illustrates a sectional view of an open carrier of the disclosure

FIG. 5 shows the carrier with the liner extended, with a separate bag being pulled over the carrier and the hand.

FIG. 6 illustrates the picking up of waste using the carrier and a separate waste bag.

FIG. 7 illustrates the withdrawal of the carrier and a separate waste bag back into the sleeve of the carrier.

FIG. 8 illustrates shows the separate waste bag tied off in the carrier.

FIG. 9 illustrates a representative carrier with stiffeners inserted into an extended liner.

FIG. 10 shows a sectional view of a representative carrier with stiffeners inserted into an extended liner.

### DETAILED DESCRIPTION OF MODES OF PRACTICING THE DISCLOSURE

As described herein, the disclosure includes a bag-like carrier for picking up and isolating items. The carrier includes without limitation a sleeve and a liner. In some embodiments, the sleeve comprises a front side and a back side, and a top and a bottom end. In such cases, the sides may be formed from two pieces of fabric. The pieces of fabric are sewn together on two opposing sides to form seams. The sides that are not sewn together form the upper and lower openings of the sleeve. In some cases, the two halves of fabric may be rectilinear so that when the sleeve is flattened by folding along the seams, the sleeve takes a rectangular shape. When flattened, the upper and lower openings are in closed or substantially closed positions. When the two halves are separated, the sleeve may form a roughly cylindrical shape with upper and lower openings in open positions through which a hand or object can extend, and a sleeve interior to which a liner may be attached. Of course, in other embodiments shapes other than rectangular are possible, so long as a hand or object can be extended through the upper and lower openings of the sleeve.

In many embodiments, a liner is attached to the sleeve interior. In some cases, the liner may be formed from fabric closed on three sides, thus forming a bag or pocket with an interior, an exterior, and an open side along the top of the liner. In some cases, the top of the liner is attached near to the upper opening of the sleeve with attachment means, so that when the upper opening of the sleeve is in an open position, the liner is also in an open position. Similarly, when the upper opening of the sleeve is in a closed or substantially closed position, the liner is also in a closed or substantially closed position. As a non-limiting example, the top of the liner may be joined to the sleeve approximately one and one half inches down from the top of the sleeve. In such an example, the liner is pushed down into the interior of the sleeve in a stowed position. In many cases, the top of the liner is sewn into the sleeve. In other cases, the liner may be attached with glue, thread, or combinations thereof. In yet other cases, the top of the liner may be removably attached to the sleeve. Non-limiting examples of removable attachment include hook and loop fasteners, zippers, and snap fasteners. Removable attachment of the liner allows the liner and the sleeve to be separately cleaned and stored.

In some embodiments, the exterior of the liner includes a pouch-like casing or channel of fabric into which a stiffener may be threaded or inserted. The casing or channel may be formed by stitching an additional layer of fabric onto the lining exterior into which a stiffening material may be inserted. Non-limiting examples of stiffener material include plastic and card board. In some cases, the liner will include a stiffener on the front and back sides of a carrier. The stiffeners are separated by liner material at the bottom of the liner.

In many embodiments, that sleeve is formed from moisture resistant or non-permeable fabric. Non-limiting examples of fabric that may be used to form the sleeve include 430 denier nylon urethane coated packcloth; 500 Denier 8 oz. urethane coated nylon Cordura; 200 Denier urethane coated nylon Oxford; neoprene; laminated cotton; oilcloth; vinyl; and combinations thereof. In many embodiments, that liner is formed from moisture resistant or non-permeable fabric. Non-limiting examples of fabric that may be used to form the liner include silicone coated ripstop nylon, available in varying weights, and silicone rubber, latex, rubber and vinyl sheeting, and combinations thereof. In other embodiments, the sleeve or the liner may be formed from plastic or other plastic fiber materials. By way of non-limiting examples, the sleeve and liner may be formed from thermosetting or thermoplastic materials molded or extruded under heat and pressure.

In some cases, two pieces of plastic or other plastic fiber materials may be laminated at opposite ends to form a sleeve with two seams. In alternative cases, the sleeve may be extruded in a cylindrical shape and pressed to form a front and back side. In some cases, plastic or other plastic fiber materials may be laminated on two to three sides to form a pocket-like liner with three closed sides and an opening on one side. In alternative cases, the liner may be formed from an extruded plastic shape that is pressed on one or more sides to form a bag-like liner. The present invention is intended to cover any fabric or plastic materials as come within known or customary practice within the art to which the disclosure pertains and as may be applied to the invention.

Additional embodiments of the disclosure include closure devices to assist in the closure of the upper opening of the sleeve. When the sleeve is in a closed or substantially closed position, closure means helps keep the sleeve closed to prevent objects from falling into the liner and to prevent items within the liner from escaping. Non-limiting examples of closure devices include drawstrings, cords, snap fasteners, hook and loop fasteners, magnetic snap fasteners, and metal springs sewn into the sleeve along its top edges. Snap fasteners may be formed from Marine-grade anodized brass or stainless steel and may be finished in a variety of colors.

Embodiments of the disclosed carrier include one or more pocket-like storage compartments formed on the exterior of the sleeve. In some cases, a side of the sleeve includes a single storage compartment formed by attaching an additional piece of material on three sides of the sleeve, leaving the top open. In other cases, more than one storage compartment on one side of the sleeve may be formed by attaching more than one piece of material in the manner described, or by dividing a single compartment with additional sewing. In yet other instances, the disclosed carrier includes a storage compartment on each of the front and back sides of the sleeve exterior. The storage compartments of the present invention may be used to hold unused separate waste bags or extra disposable liners, or other personal items such as keys, sunglasses, cosmetics, sunscreen, wallets, cell phones, personal digital assistants and the like. In some cases a storage compartment on the front side of the sleeve may be closed with a zipper, while a storage compartment on the back side is left open on the top. Other means of closing the storage compartment include without limitation snap fasteners, hook and loop fasteners and magnetic snap fasteners.

In some embodiments, the carrier of the disclosure may include a hole, slit or other opening near the top of the sleeve and/or liner fabric to permit the attachment of additional hardware to the carrier. In some cases, a hole or slit will be reinforced with additional fabric or sewn seams, grommets or eyelets. By way of a non-limiting example, the grommets may be 0.25″ in inner diameter and made from nickel-plated, oxidized black or unfinished brass. In some embodiments, the carrier of the disclosure may include rings or similar hardware inserted through the hole or slit to allow the ring, and therefore the carrier, to be attached to another object. Non-limiting examples of hardware used together with a hole or slit of the carrier include rings, split key rings, carabineers, and strings or loops of cord. By way of non-limiting examples, the split key rings may be 20 to 24 mm in diameter and may be formed from nickel-plated steel, brass plated steel or black zinc, or they may have a hardened and tempered epoxy finish.

In some cases, a strap with a snap hook, clip or toggle at one end may be attached to the ring of the carrier. In other cases, the snap hook or toggle of the strap is directly attached to the carrier through the hole or slit. By way of a non-limiting example, a snap hook may be formed from 3/4″ or 1″ black molded plastic, nickel-plated steel, or stainless steel. The strap may be made from woven nylon, nylon or polypropylene webbing, or nylon or polypropylene cording, all available in various widths and colors, by way of non-limiting examples. The strap may include a snap fastener, a hook and loop fastener, or other quick release means that allows the strap to form a loop at one end of the strap. The loop end of the strap can thus be opened and closed around another object such as a belt, leash, backpack, or purse, or handles and straps of such items, as non-limiting examples. Consequently, the strap may be used as a means to connect the carrier with other objects such as belt, leash, backpack, or purse, or handles and straps of such items.

In alternative embodiments, the carrier of the disclosure may include a portion of a quick release buckle connected to fabric, cording or webbing that is attached to the carrier. The other portion of the buckle attached to a strap may be made from woven nylon, nylon or polypropylene webbing, or nylon or polypropylene cording, all available in various widths and colors, by way of non-limiting examples. The strap may include a snap fastener, a hook and loop fastener, or other quick release means that allows the strap to form a loop at one end of the strap. The strap can thus be opened and closed around another object such as a belt, leash, backpack or purse as non-limiting examples. When the buckle is fastened, the strap and carrier are connected, and so through the strap, the carrier may be attached to such objects.

In yet other embodiments, the carrier of the disclosure may include a piece of fabric, cording or webbing sewn into the carrier at or near the top. The fabric, cording or webbing attaches an O-ring or a D-ring to which a snap hook of the strap may be engaged.

The present invention is intended to cover any quick release means, and means for removably attaching the sleeve or carrier to a strap, as come within known or customary practice within the art to which the disclosure pertains and as may be applied to the invention.

Of course, the carrier of the present invention may be manufactured in different sizes to suit the application or the hand size of the user. For additional safety, the carrier may also include reflective tape, ribbon, piping or cording, and/or small LED blinker or flashing lights attached to the carrier or the strap. The carrier may also be provided in a variety of color combinations and decorated with various types of decorative trims and notions, such as lace, decorative fabric, crystals and beads as non-limiting examples.

As described herein, a method of the invention is practiced with a bag-like carrier of the disclosure comprising a sleeve with an attached liner. The liner and the sleeve are attached at or near their respective top ends, which allows the top, or open end, of the liner to be moved from an open to a closed or substantially closed position along with the top of the sleeve. The liner may be moved from a first stowed position within the sleeve interior to a second extended position in which a portion of the liner extends past the opened upper opening of the sleeve. In many embodiments, the extension of the liner of the disclosure is practiced by inserting a hand up through the bottom and lower opening of the sleeve to contact the exterior of the liner stowed within the sleeve interior. The hand then pushes the liner up through the upper opening of the sleeve into an extended position, thus exposing the interior of the liner. The liner remains attached to the sleeve at its top end. In the extended position, a separate bag can be placed or fitted over the extended liner and sleeve, and over the hand beneath. Non-limiting examples of separate bags include plastic grocery store bags, plastic re-closable bags, garbage bags, commercially available animal waste pickup bags, or other non-permeable or moisture resistant bags. In other embodiments, the extended liner and sleeve may be covered by a sheet of non-permeable or moisture resistant material of sufficient size to cover and grasp the item. The hand can then manipulate the liner and the separate bag to pick up and isolate items. After the item is grasped by closing the liner and bag around the item, the hand can pull liner, bag and item back through the upper opening of the sleeve, until the liner is returned to a stowed position. The bag with the item rests in the interior of the stowed liner and can be transported in the carrier. In some cases, the method is practiced in connection with pet or animal walking and the collection of animal waste. The liner is a second layer of sanitary protection for picking up such waste. In other cases, the method may be practiced in connection with the collection of garbage.

In other embodiments, the method may be practiced without a separate waste bag by grasping the items with the liner and pulling the liner back down into the sleeve interior such that the item is isolated in the liner. In such cases, the liner may be removably attached to the sleeve to allow frequent cleaning or replacement. In other cases, the liner may be formed from inexpensive disposable materials to permit frequent replacement.

In yet other embodiments, the method may be practiced with the addition of stiffeners inserted into a channel of the liner. The stiffeners may also be hand-manipulated to assist in the grasping, collecting or scraping of the item or waste material.

Of course, the method may include the attachment of the carrier to a strap and a leash before the waste is picked up, detachment of the carrier from the strap to pick up the waste, and re-attachment of the carrier to the strap after the waste has been picked up and contained.

As described herein, the disclosure includes a system for carrying or transporting items, including animal waste, that comprises a carrier and strap as described herein, wherein the strap has a first and a second end, said first end connected to a leash, belt, purse, backpack and the like, and said second end connected to the carrier, and waste pickup bags. In some embodiments, the first strap end is removably attached to a leash, belt, purse, backpack and the like, and the second strap end is removably attached to the carrier or sleeve. In other embodiments, the carrier further comprises a storage compartment in which separate bags, such as waste pickup bags, are stored.

Having now generally provided the disclosure, the same will be more readily understood through reference to the following examples which are provided by way of illustration, and are not intended to be limiting of the disclosure, unless specified.

### EXAMPLES

### Example 1

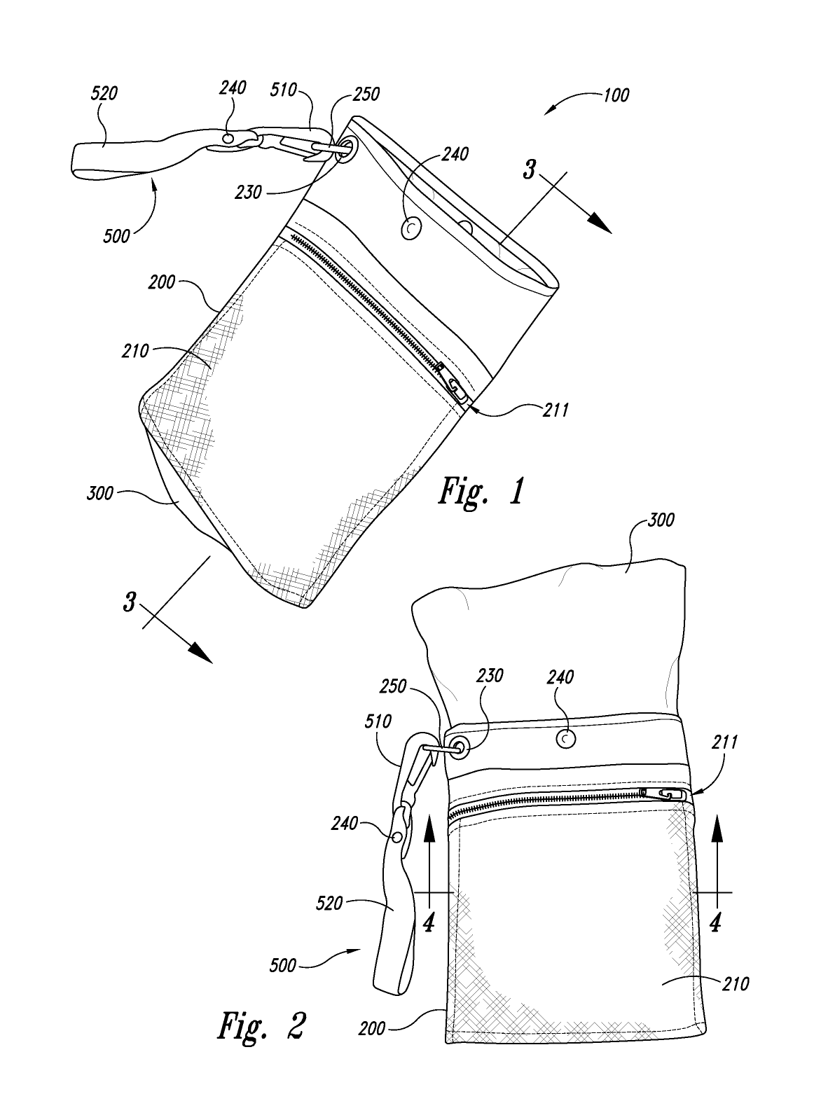

Referring to FIGS. 1 and 2, a carrier 100 of the disclosure is shown together with strap 500. The carrier includes sleeve 200 and liner 300. The sleeve 200 includes storage compartments 210 and 220. Storage compartment 210 is on the front side of the carrier, and storage compartment 220 is on the back side of the carrier. Storage compartment 210 may be closed with zipper 211. Storage compartment 220 is open on side 221.

In FIG. 1, liner 300 is shown in a stowed position. Liner 300 may be extended from a stowed position to an extended position as shown in FIG. 2 by pushing the liner from the bottom of sleeve 200 up through its upper opening. The interior of liner 300 is exposed in FIG. 2.

Carrier 100 includes snap fastener 240 that is used to help close the upper opening of the sleeve to prevent objects from falling in accidentally or from escaping. Carrier 100 also includes grommet 230, which is used together with a hole that penetrates the carrier. Strap 500 is connected to carrier 100 by snap hook 510. The strap also includes webbing or cording 520 that is attached to the snap hook at one end and forms a loop at the other end with snap fastener 240.

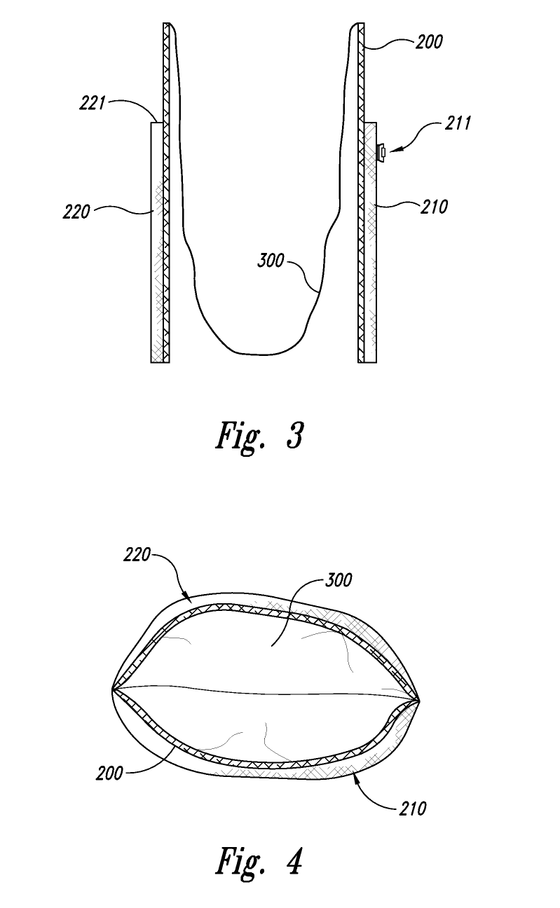

Referring to FIG. 3, liner 300 is attached to the sleeve near its top of the sleeve, and the remainder is pushed into the interior of the sleeve in a stowed position. The closed sides of the liner form a bag or pocket within the carrier. Referring to FIG. 4, liner 300 occupies the sleeve interior in a stowed position.

### Example 2

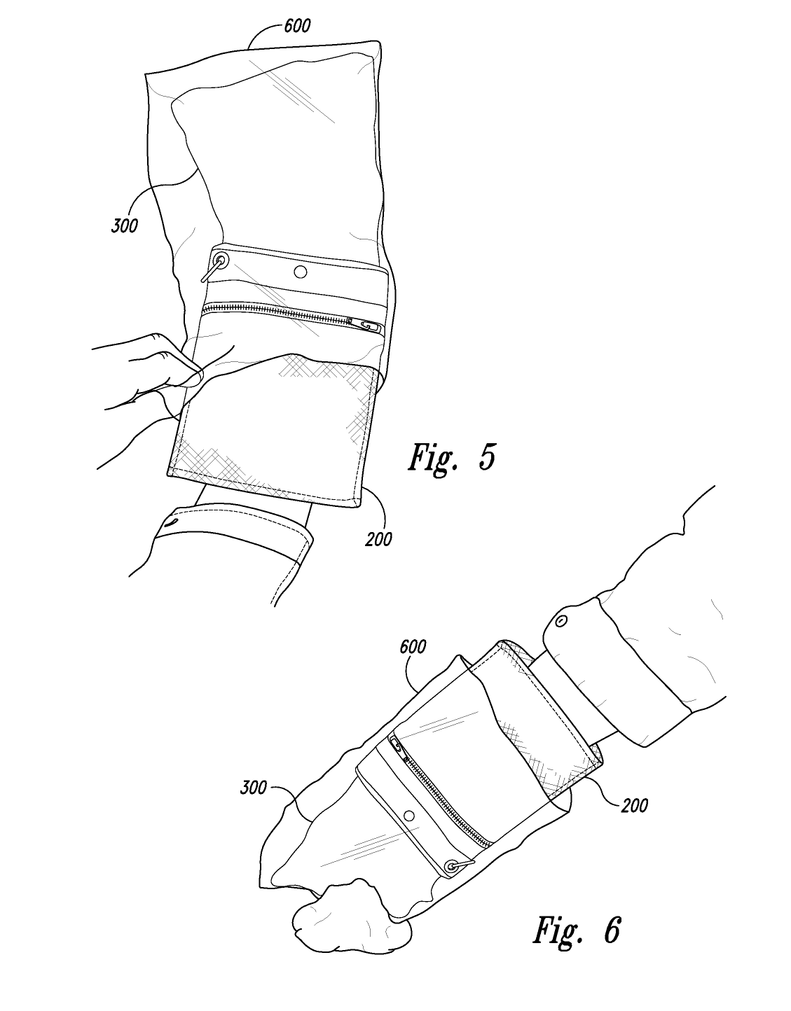

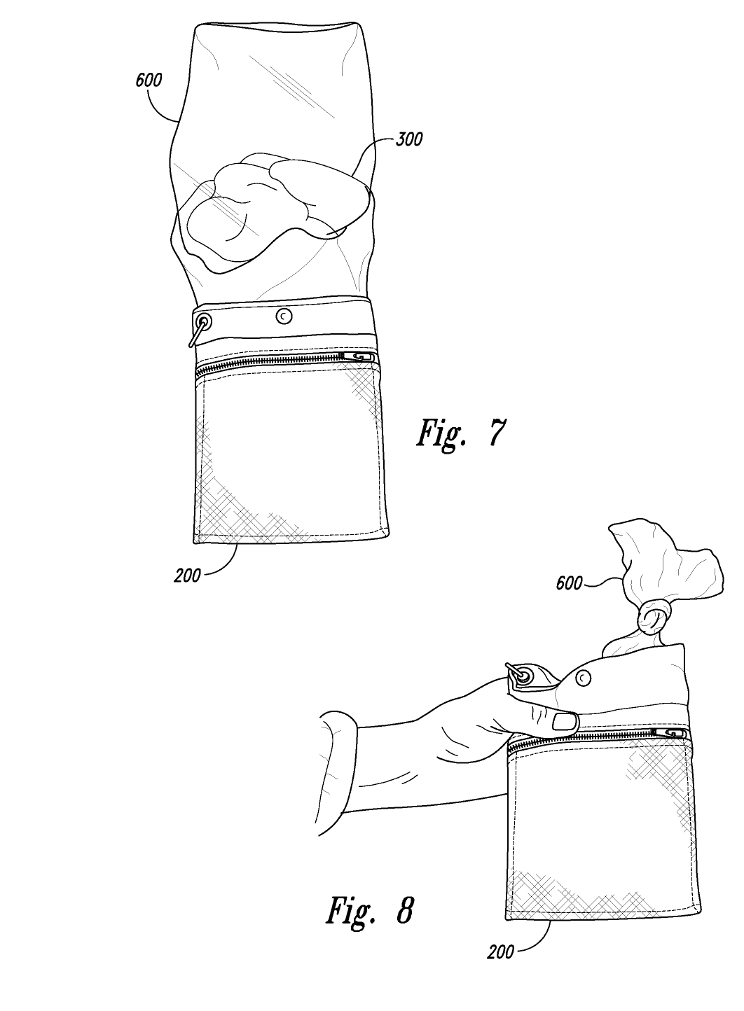

Referring to FIG. 1, carrier 100 is quickly removed from attachment through strap 500 to a leash by unclipping snap hook 510 from ring 250 at the corner of carrier 100. Referring to FIG. 5, a dog walker places his or her other hand into the bottom opening of sleeve 200 and pushes liner 300 up through carrier 100. Waste pickup bag 600 is placed over the top of extended liner 300 and carrier 100. There are now two layers covering the dog walker's hand as the waste is gathered in FIG. 6. When all the waste is gathered, the waste and bag 600 is retracted by pulling liner 300 back down into carrier 100. As shown in FIG. 7, bag 600 is inverted in this process so that the waste remains contained in the bag. Bag 600 may be tied off and dropped back into carrier 100 as in FIG. 10. The dog walker then clips carrier 100 back onto the leash by attaching snap hook 510 to ring 250.

### Example 3

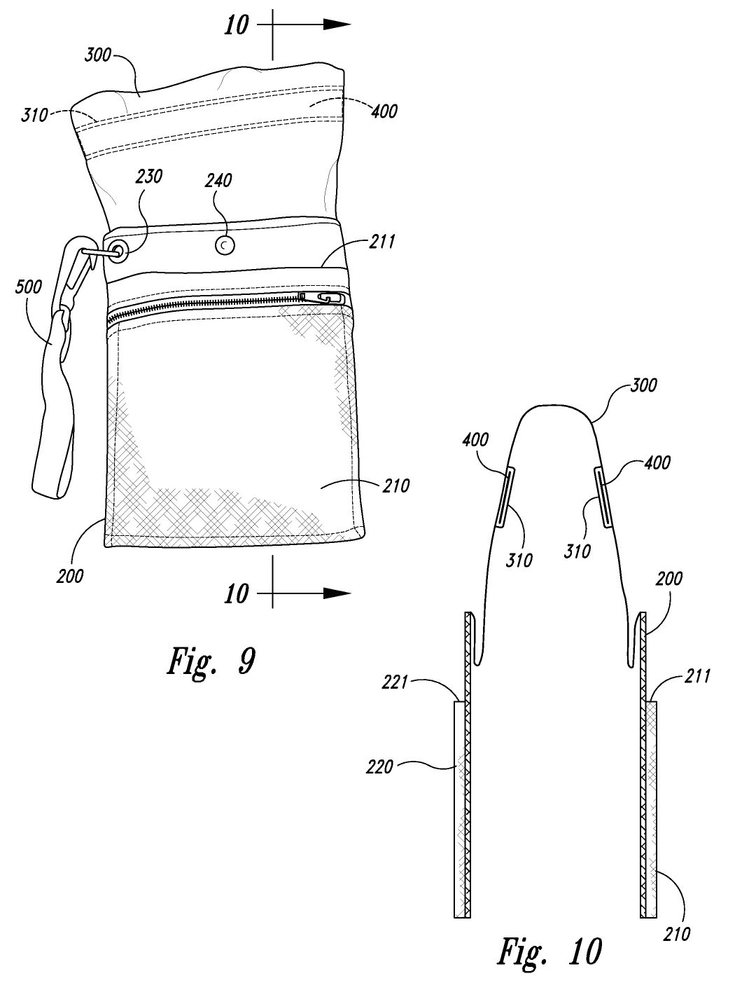

Referring to FIGS. 9 and 10, carrier 100 includes additional material sewn into liner 300 to provide channels 310 for insertion of stiffeners 400. Bag 600 is placed over extended liner 300 as demonstrated in FIG. 5. Stiffeners 400 are manipulated together with bag 600 and liner 300 to pick up waste or other items.

All references cited herein, including patents, patent applications, and publications, are hereby incorporated by reference in their entireties, whether previously specifically incorporated or not.

Having now fully described the inventive subject matter, it will be appreciated by those skilled in the art that the same can be performed within a wide range of equivalent parameters, concentrations, and conditions without departing from the spirit and scope of the disclosure and without undue experimentation.

While this disclosure has been described in connection with specific embodiments thereof, it will be understood that it is capable of further modifications. This application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth.

What is claimed is:

1. A carrier for picking up and isolating an item comprising:
a sleeve comprising an upper opening and a lower opening, wherein said upper opening has an open position and a closed position; and
a liner attached to said sleeve.

2. The carrier of claim 1, wherein said liner is movably attached to said sleeve.

3. The carrier of claim 2, wherein said liner may be moved from a first stowed position to a second extended position in which a portion of said liner extends past the upper opening of said sleeve.

4. The carrier of claim 1, wherein said sleeve comprises a closure device.

5. The carrier of claim 4, wherein said carrier includes stiffeners inserted into channels in said liner.

6. The carrier of claim 1, wherein said sleeve comprises a grommet disposed in said sleeve.

7. The carrier of claim 6, wherein a ring or clip is connected to said sleeve through said grommet.

8. The carrier of claim 7, wherein said ring or clip is connected to a strap.

9. The carrier of claim 1, wherein said liner comprises moisture-resistant fabric.

10. The carrier of claim 9, wherein said fabric comprises silicone impregnated ripstop nylon.

11. The carrier of claim 1, wherein said sleeve comprises a storage compartment with an opening.

12. The carrier of claim 11, wherein said storage compartment is closable with a zipper.

13. The carrier of claim 1, further comprising means for attaching said liner to said sleeve.

14. The carrier of claim 1, further comprising means for closing said upper opening of said sleeve.

15. The carrier of claim 1, further comprising means for removably attaching the sleeve to a strap.

16. A method for picking up and isolating an item comprising:
extending the upper opening of the carrier of claim 1 to move the carrier into an open position;
pushing out the liner of said carrier into an extended position by moving a hand through the lower opening of the carrier to contact said liner and push the liner out of the upper opening of the carrier;
placing a bag over said carrier and hand in the extended position,
grasping an item by closing said bag and liner about said item; and
withdrawing said hand, liner, bag and item back through the upper opening of said carrier such that the item is contained within said carrier.

17. The method of claim 16, wherein said carrier is removably attached to a leash or belt before and after picking up said item.

18. A system for carrying waste-related items comprising:
the carrier of claim 1;
a strap comprising a first end and a second end, wherein said first end may be connected to a leash or belt and said second end may be connected to said carrier; and
waste pickup bags.

19. The system of claim 18, wherein said first strap end is removably attached to said leash or belt and said second strap end is removably attached to said sleeve.

20. The system of claim 18, wherein said carrier comprises a storage compartment into which waste pickup bags are stored.
